(19) United States
(12) Patent Application Publication
(10) Pub. No.: US 2026/0140574 A1
(43) Pub. Date: May 21, 2026

(54) INTERACTIVE DEVICE

(71) Applicant: LITE-ON TECHNOLOGY CORPORATION, TAIPEI CITY (TW)

(72) Inventors: Min-Yi Wang, TAIPEI CITY (TW); YUAN-YUAN LEE, TAIPEI CITY (TW); HUANG-YIN CHEN, TAIPEI CITY (TW); Sung-Hao Chou, TAIPEI CITY (TW); PEI-JUI LEE, TAIPEI CITY (TW)

(21) Appl. No.: 19/393,492

(22) Filed: Nov. 18, 2025

Related U.S. Application Data
(60) Provisional application No. 63/723,133, filed on Nov. 21, 2024.

(30) Foreign Application Priority Data
Jun. 13, 2025 (TW) 114122167

(51) Int. Cl. G06F 3/02; G06F 3/14; G06F 3/16

(52) U.S. Cl. CPC G06F 3/0227; G06F 3/0216; G06F 3/0219; G06F 3/14; G06F 3/165

(57) ABSTRACT

An interactive device, a functional element, and a control method of the interactive device. The interactive device includes a supporting base, a first functional element, and a second functional element. The supporting base includes a supporting surface, a bottom surface and an internal space formed between the supporting surface and the bottom surface. The supporting surface further includes a plurality of mounting regions. The first functional element includes a first functional surface and a first mounting surface, and the first mounting surface is disposed on one of the mounting regions. The second functional element includes a second functional surface and a second mounting surface, and the second mounting surface is disposed on at least another one of the mounting regions.

### CROSS-REFERENCE TO RELATED PATENT APPLICATION

This application claims the benefit of priorities to the U.S. Provisional Patent Application Ser. No. 62/723,133, filed on Nov. 21, 2024, and Taiwan Patent Application No. 114122167, filed on Jun. 13, 2025. The entire content of each of the above identified applications is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an electronic interactive device, and more particularly to an electronic interactive device having replaceable electronic functional elements.

### BACKGROUND OF THE DISCLOSURE

Electronic devices bring numerous conveniences to the life of human beings. As such, how to facilitate operations of the electronic devices to be more user-friendly has become an important issue. For example, since a storage capacity and a processor performance of a computer have increased significantly, the computer has become increasingly versatile. In order to operate the computer efficiently, a mouse, a keyboard, or a touchpad is used as a functional element of the computer. Users manipulate the mouse, the keyboard, or the touchpad to execute desired computer functions.

Currently, there is a keyboard on the market that can be connected to external function modules. However, a connection location, a connection method, and a function of each external function module are fixed, and replaceability of each external function module is low.

### SUMMARY OF THE DISCLOSURE

In response to the above-referenced technical inadequacies, the present disclosure provides an interactive device.

In order to solve the above-mentioned problems, one of the technical aspects adopted by the present disclosure is to provide an interactive device. The interactive device includes a supporting base, a first functional element, and a second functional element. The supporting base includes a supporting surface, a bottom surface, and an internal space formed between the supporting surface and the bottom surface. The supporting surface further includes a plurality of mounting regions. The first functional element includes a first functional surface and a first mounting surface, and the first mounting surface is disposed on at least one of the plurality of mounting regions. The second functional element includes a second functional surface and a second mounting surface, and the second mounting surface is disposed on at least another one of the plurality of mounting regions.

In order to solve the above-mentioned problems, another one of the technical aspects adopted by the present disclosure is to provide an interactive device. The interactive device includes a supporting base, a circuit board and a first functional element. The supporting base includes a supporting surface, a bottom surface and an internal space formed between the supporting surface and the bottom surface. A plurality of electrical interfaces is formed on the supporting surface. The circuit board is disposed in the internal space. A circuit control unit is disposed on the circuit board and is electrically connected to each of the plurality of electrical interfaces. The first functional element includes a first functional surface, a first mounting surface, and a plurality of first side surfaces that surround the first functional surface and the first mounting surface.

In order to solve the above-mentioned problems, yet another one of the technical aspects adopted by the present disclosure is to provide an interactive device. The interactive device includes a supporting base, a first mounting region, a second mounting region, a third mounting region and a fourth mounting region. The supporting base includes a supporting surface, a bottom surface, and an internal space formed between the supporting surface and the bottom surface. The first mounting region, the second mounting region, the third mounting region and the fourth mounting region are defined on the supporting surface. An area of the first mounting region is equal to an area of the third mounting region and is smaller than an area of the second mounting region. The area of the second mounting region is equal to an area of the fourth mounting region and is larger than the area of the first mounting region.

In order to solve the above-mentioned problems, yet another one of the technical aspects adopted by the present disclosure is to provide a functional element. The functional element includes a body, a distributed control circuit, an electrical interface, a wireless communication module, and a fixing portion. The distributed control circuit is disposed within the body, the electrical interface is disposed within the body and electrically connected to the distributed control circuit, the wireless communication module is disposed within the body and electrically connected to the distributed control circuit, and the fixing portion is disposed within the body. The functional element is detachably fixed to a supporting base via the fixing portion. When the functional element is fixed to the supporting base, the electrical interface is electrically connected to the supporting base.

In order to solve the above-mentioned problems, still another one of the technical aspects adopted by the present disclosure is to provide an interactive device. The interactive device includes a supporting base and at least one functional element. The supporting base includes a circuit control unit, and the at least one functional element includes a body, a distributed control circuit, an electrical interface, a wireless communication module, and a fixing portion. The distributed control circuit is disposed within the body, the electrical interface is disposed within the body and electrically connected to the distributed control circuit, the wireless communication module is disposed within the body and electrically connected to the distributed control circuit, and the fixing portion is disposed within the body. The at least one functional element is detachably fixed to the supporting base via the fixing portion. When the at least one functional element is fixed to the supporting base, the electrical interface is electrically connected to the circuit control unit.

In order to solve the above-mentioned problems, still yet another one of the technical aspects adopted by the present disclosure is to provide an interactive device. The interactive device includes a supporting base and at least one functional element. The supporting base includes a hub, and each functional element includes a body, a distributed control circuit, an electrical interface, a wireless communication module, and a fixing portion. The distributed control circuit is disposed within the body, the electrical interface is disposed within the body and electrically connected to the distributed control circuit, the wireless communication module is disposed within the body and electrically connected to the distributed control circuit, and the fixing portion is disposed within the body. The at least one functional element is detachably fixed to the supporting base via the fixing portion. When the at least one functional element is fixed to the supporting base, the electrical interface is electrically connected to the hub.

In order to solve the above-mentioned problems, still yet another one of the technical aspects adopted by the present disclosure is to provide a control method of an interactive device. The interactive device includes a supporting base and a functional element. The control method includes: detecting, by a distributed control circuit of the functional element, whether or not a hub of the supporting base is connected to a host by a wire. When the hub is connected to the host by the wire, the functional element is in a wired operation mode. When the hub is not connected to the host by the wire, the distributed control circuit activates a wireless communication module of the functional element. The functional element is switched from the wired operation mode to a wireless operation mode when the wireless communication module is activated.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a first functional element from a first angle of view according to a first embodiment of the present disclosure;

FIG. 2 is a schematic perspective view of the first functional element of FIG. 1 from a second angle of view;

FIG. 3 is a topological diagram of telecommunication connections of the first functional element of FIG. 1;

FIG. 4 is a schematic perspective view of a first usage mode of an interactive device according to the first embodiment of the present disclosure;

FIG. 5 is a schematic perspective view of a second usage mode of the interactive device of FIG. 4;

FIG. 6 is a schematic exploded view of the interactive device of FIG. 4 from the first angle of view;

FIG. 7 is a schematic exploded view of the interactive device of FIG. 4 from the second angle of view;

FIG. 8 is a topological diagram of telecommunication connections of the interactive device of FIG. 4;

FIG. 9 is a topological diagram of the telecommunication connections of the interactive device according to a second embodiment of the present disclosure;

FIG. 10 is a flow chart of a control method of the interactive device according to the first embodiment of the present disclosure;

FIG. 11 is a flow chart of the control method of the interactive device according to the second embodiment of the present disclosure;

FIG. 12 is a schematic exploded view of the interactive device according to a third embodiment of the present disclosure;

FIG. 13 is a schematic perspective view of a supporting base of the interactive device of FIG. 12;

FIG. 14 is a schematic exploded view of the interactive device according to a fourth embodiment of the present disclosure;

FIG. 15 is a schematic exploded view of the interactive device according to a fifth embodiment of the present disclosure;

FIG. 16 is a schematic exploded view of the interactive device according to a sixth embodiment of the present disclosure;

FIG. 17 is a schematic planar view of the interactive device according to a seventh embodiment of the present disclosure;

FIG. 18 is a schematic planar view of the interactive device according to an eighth embodiment of the present disclosure;

FIG. 19 is a functional block diagram of a circuit architecture of the supporting base of the interactive device according to one embodiment of the present disclosure;

FIG. 20 is a schematic diagram of the interactive device in a first configuration according to the third embodiment of the present disclosure; and

FIG. 21 is a schematic diagram of the interactive device in a second configuration according to the third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

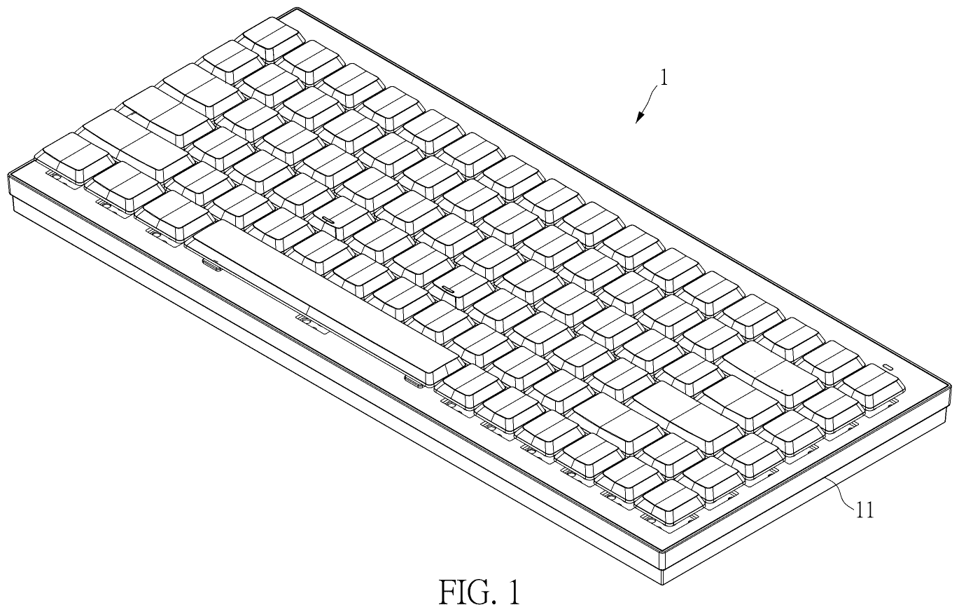

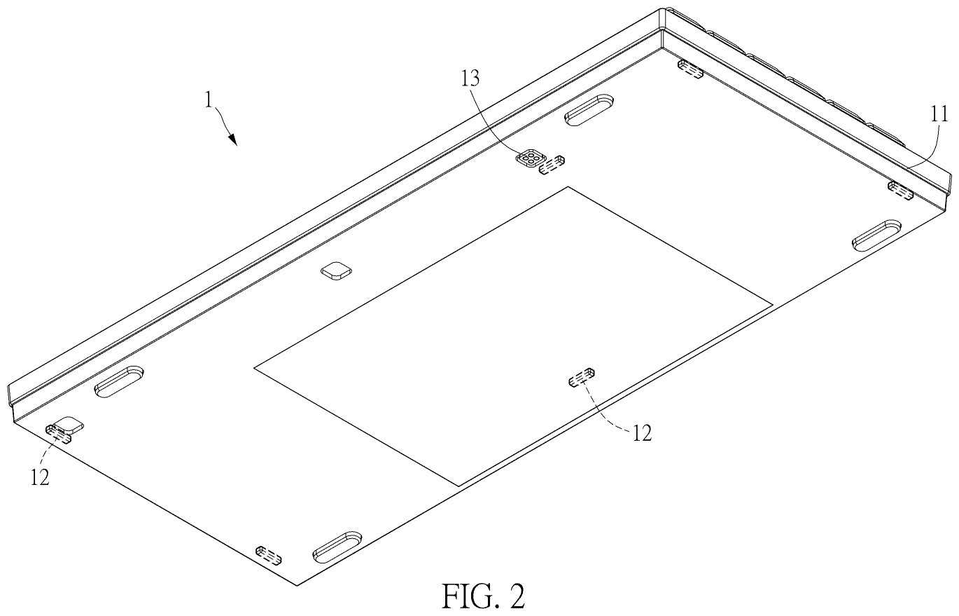

FIG. 1 is a schematic perspective view of a first functional element from a first angle of view according to a first embodiment of the present disclosure, and FIG. 2 is a schematic perspective view of the first functional element of FIG. 1 from a second angle of view. Referring to FIG. 1 and FIG. 2, a first functional element 1 is, for example, a physical keyboard. The first functional element 1 includes a body 11, a plurality of fixing portions 12, and an electrical interface 13. A plurality of keys are movably assembled to the body 11, and the plurality of fixing portions 12 and the electrical interface 13 are fixed to the body 11. The fixing portions 12 may be, for example, magnets, magnetic attractors, compression-expansion elements, or latches. An interface configuration of the electrical interface 13 or an electrical contact (such as pin) layout of the electrical interface 13 can be adjusted according to practical requirements, so as to accommodate a standardized communication interface, such as a universal serial bus (USB), an inter-integrated circuit (I²C), or a serial peripheral interface (SPI). The electrical interface 13 can be configured with a standard or compatible interface configuration and pin layout according to the communication interface specification.

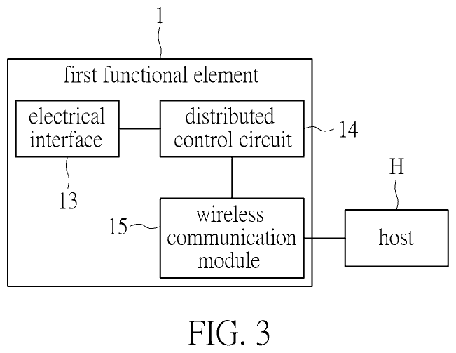

FIG. 3 is a topological diagram of telecommunication connections of the first functional element of FIG. 1. Referring to FIG. 3, the first functional element 1 further includes a distributed control circuit 14 and a wireless communication module 15. The distributed control circuit 14 and the wireless communication module 15 are fixed within the body 11, and the distributed control circuit 14 is electrically connected to the electrical interface 13 and the wireless communication module 15. The distributed control circuit 14 is, for example, a programmable logic controller circuit (PLC), a micro-processor circuit (MPC), a micro-control circuit (MCC), or other processors or controllers having signal processing functions.

The wireless communication module 15 includes, for example, a processor, a radio frequency (RF) circuit, a baseband circuit, a media access control (MAC) circuit, and an antenna. The processor is connected to the MAC circuit, the MAC circuit is connected to the baseband circuit, the baseband circuit is connected to the RF circuit, and the RF circuit is connected to the antenna. Signals from the processor are sequentially processed by the MAC circuit, the baseband circuit, and the RF circuit. The processed signals become RF signals, and are transmitted to the antenna. The RF circuit also receives external RF signals. These external RF signals are sequentially processed by the RF circuit, the baseband circuit, the MAC circuit, and the processor.

The wireless communication module 15 of the first functional element 1 includes a sleep state and an active state. The distributed control circuit 14 switches the wireless communication module 15 between the sleep state and the active state according to preset conditions, so as to achieve power conservation. When being is in the active state, the wireless communication module 15 can be wirelessly communicated with a host H.

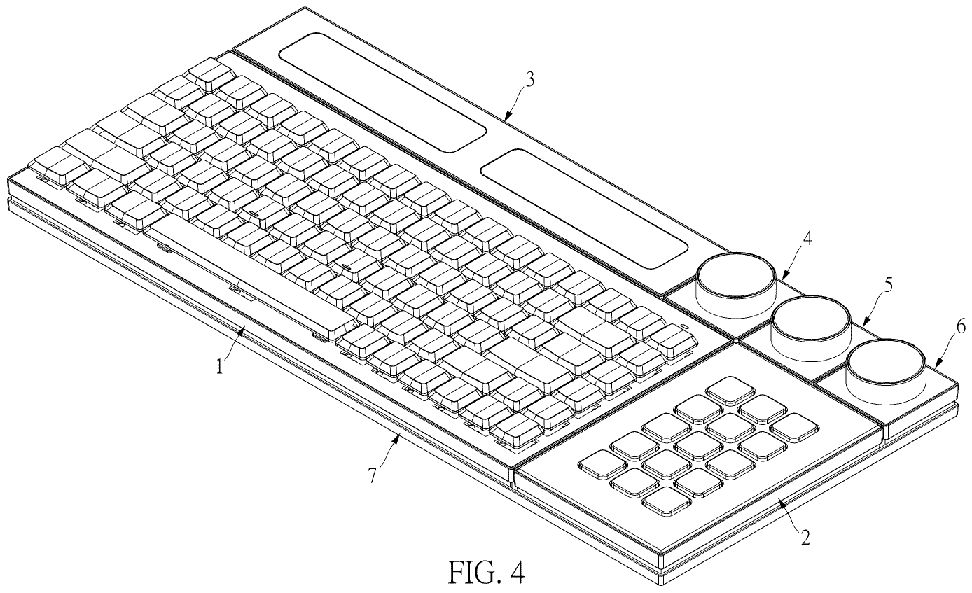

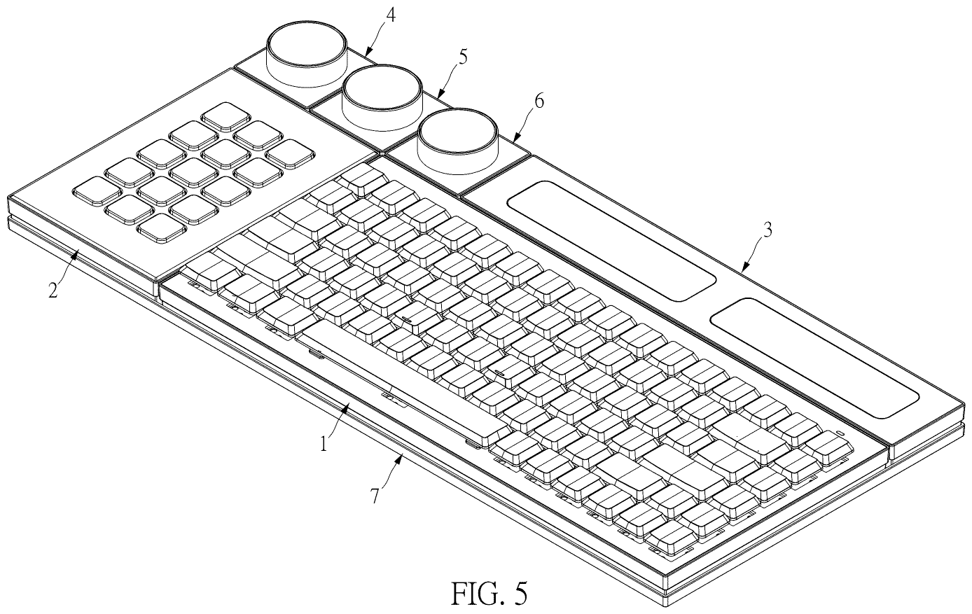

FIG. 4 is a schematic perspective view of a first usage mode of an interactive device according to the first embodiment of the present disclosure, and FIG. 5 is a schematic perspective view of a second usage mode of the interactive device of FIG. 4. Referring to FIG. 4 and FIG. 5, the interactive device includes the first functional element 1, a second functional element 2, a third functional element 3, a fourth functional element 4, a fifth functional element 5, a sixth functional element 6, and a supporting base 7. The first functional element 1, the second functional element 2, the third functional element 3, the fourth functional element 4, the fifth functional element 5, and the sixth functional element 6 are detachably fixed to the supporting base 7. Since the first functional element 1, the second functional element 2, the third functional element 3, the fourth functional element 4, the fifth functional element 5, and the sixth functional element 6 are detachably fixed to the supporting base 7, a position of the first functional element 1 and a position of the second functional element 2 can be interchanged, and a position of the third functional element 3, a position of the fourth functional element 4, a position of the fifth functional element 5, and a position of the sixth functional element 6 can be interchanged.

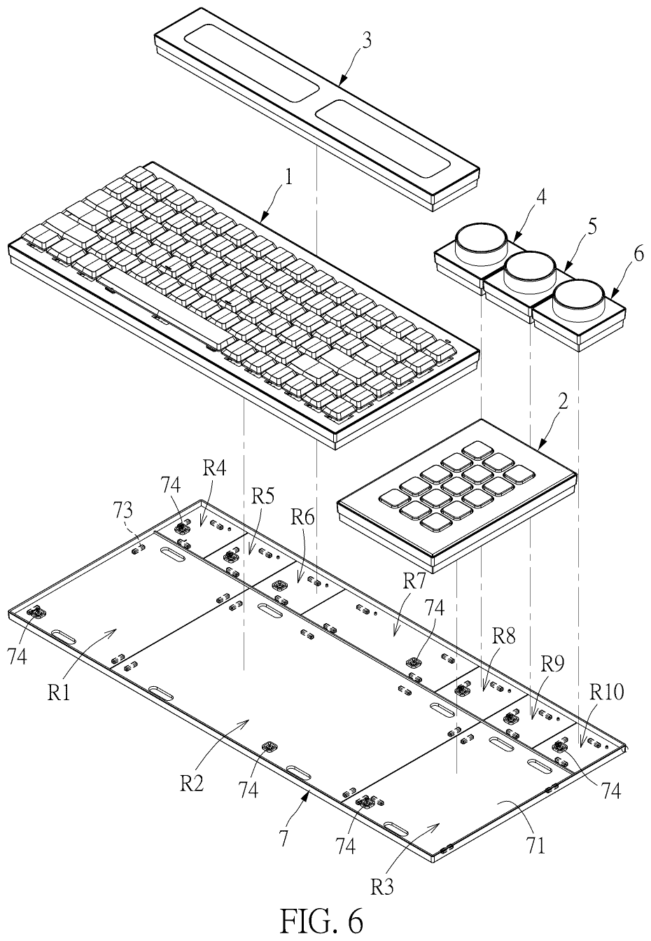

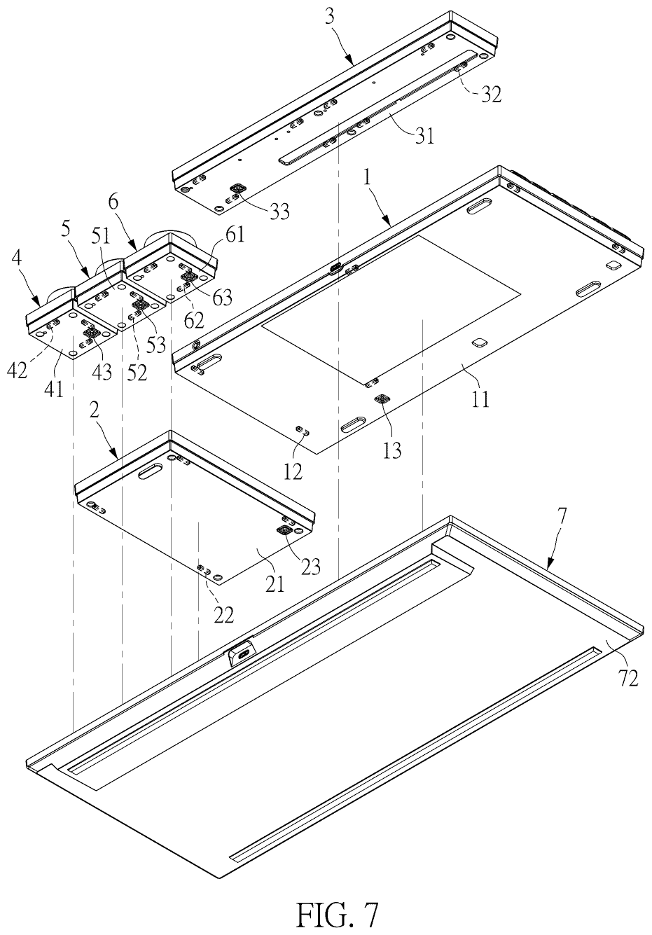

FIG. 6 is a schematic exploded view of the interactive device of FIG. 4 from the first angle of view, and FIG. 7 is a schematic exploded view of the interactive device of FIG. 4 from the second angle of view. Referring to FIG. 6 and FIG. 7, the supporting base 7 has a supporting surface 71 and a bottom surface 72. The supporting surface 71 corresponds to the bottom surface 72, and the supporting surface 71 includes a first mounting region R1, a second mounting region R2, a third mounting region R3, a fourth mounting region R4, a fifth mounting region R5, a sixth mounting region R6, a seventh mounting region R7, an eighth mounting region R8, a ninth mounting region R9, and a tenth mounting region R10.

The supporting base 7 includes a plurality of fixing portions 73 and a plurality of electrical interfaces 74, and the plurality of fixing portions 73 and the plurality of electrical interfaces 74 are disposed on the supporting surface 71. The fixing portions 73 may be, for example, magnets, magnetic attracting elements, compression-expansion elements, or latches, while the electrical interfaces 74 may be, for example, USB-compatible interfaces. The first to tenth mounting regions R1 to R10 are each provided with at least one of the fixing portions 73 and at least one of the electrical interfaces 74.

The first functional element 1 can be secured to the first mounting region R1 and the second mounting region R2, or to the second mounting region R2 and the third mounting region R3 via magnetism, gravity, or snap-fitting forces. When the first functional element 1 is secured to the first mounting region R1 and the second mounting region R2, positions of the plurality of fixing portions 12 of the first functional element 1 correspond to positions of the plurality of fixing portions 73 located in the first mounting region R1 and the second mounting region R2, respectively. Furthermore, the electrical interface 13 of the first functional element 1 contacts the electrical interface 74 located in the second mounting region R2, thereby establishing an electrical connection between the first functional element 1 and the supporting base 7. However, the present disclosure is not limited thereto.

In other embodiments, when the position of at least one of the fixing portions 12 of the first functional element 1 corresponds to the position of at least one of the fixing portions 73 located in the first mounting region R1 or the second mounting region R2, the first functional element 1 can be secured on the first mounting region R1 or the second mounting region R2. When the electrical interface 13 of the first functional element 1 contacts at least one of the electrical interfaces 74 located in the first mounting region R1 or the second mounting region R2, the first functional element 1 can work normally.

Specifically, the electrical interface 13 of the first functional element 1 is a USB-compatible interface, such as an electrical contact pad, a conductive groove, or a conductive hole. The electrical interface 74 of the supporting base 7 is also a USB-compatible interface, such as a conductive pin, a spring-loaded pin, or a conductive post. Referring to of FIGS. 6 and 7, when the electrical interface 13 of the first functional element 1 contacts a top portion of the electrical interface 74 of the supporting base 7, the electrical interface 13 is electrically connected with the electrical interface 74. A spring is connected to a bottom portion of the electrical interface 74. The spring accepts a pressure of the electrical interface 13, and is changed from an initial state to a compressed state, so as to compensate a distance error between the electrical interface 13 of the first functional element 1 and the electrical interface 74 of the supporting base 7.

The second functional element 2 is, for example, a shortcut keyboard. The second functional element 2 includes a body 21, a plurality of fixing portions 22, and an electrical interface 23. A plurality of keys are movably assembled to the body 21, and the plurality of fixing portions 22 and the electrical interface 23 are fixed to the body 21. Each fixing portion 22 is, for example, a magnet, a ferromagnetic, a magnetic attracting member, a compression-expansion member, or a latch, and the electrical interface 23 is, for example, a USB-compatible interface.

The second functional element 2 can be secured to the first mounting region R1 of the supporting base 7 or the third mounting region R3 of the supporting base 7 through magnetic forces, gravity, or snap-fitting forces. When the first functional element 1 is secured to the third mounting region R3, positions of the plurality of fixing portions 22 of the second functional element 2 correspond to positions of the plurality of fixing portions 73 located in the third mounting region R3, and the electrical interface 23 of the second functional element 2 contacts the electrical interface 74 located in the third mounting region R3, thereby establishing an electrical connection between the second functional element 2 and the supporting base 7. In other embodiments, when the position of at least one of the fixing portions 22 of the second functional element 2 corresponds to the position of one of the fixing portions 73 located in the third mounting region R3, the second functional element 2 can be fixed to the third mounting region R3.

The third functional element 3 is, for example, a display, and includes a body 31, a plurality of fixing portions 32, and an electrical interface 33. The fixing portions 32 and the electrical interface 33 are fixed to the body 31. Each fixing portion 32 is, for example, a magnet, a magnetic attracting member, a compression-expansion member, or a latch, and the electrical interface 33 is, for example, a USB-compatible interface.

The third functional element 3 can be fixed to four mounting regions of the supporting base 7 by magnetic forces, gravity, or snap forces. These four mounting regions are adjacent to each other, and include the seventh mounting region R7. For example, these four mounting regions can be the sixth mounting region R6 to the ninth mounting region R9, the fourth mounting region R4 to the seventh mounting region R7, or the seventh mounting region R7 to the tenth mounting region R10. When the third functional element 3 is secured to the fourth mounting region R4, the fifth mounting region R5, the sixth mounting region R6, and the seventh mounting region R7, the positions of the fixing portions 32 of the third functional element 3 correspond to the positions of the fixing portions 73 located in the fourth mounting region R4, the fifth mounting region R5, the sixth mounting region R6, and the seventh mounting region R7, and the electrical interface 33 of the third functional element 3 contacts the electrical interface 74 located in the fourth mounting region R4, thereby establishing an electrical connection between the third functional element 3 and the supporting base 7.

In other embodiments, when the position of at least one of the fixing portions 32 of the third functional element 3 corresponds to the position of one of the fixing portions 73 located in the fourth mounting region R4 to the seventh mounting region R7 or the seventh mounting region R7 to the tenth mounting region R10, the third functional element 3 can be fixed to the supporting base 7. When the electrical interface 33 of the third functional element 3 contacts one of the electrical interfaces 74 located in the fourth mounting region R4 to the seventh mounting region R7 or the seventh mounting region R7 to the tenth mounting region R10, the third functional element 3 can work normally.

The fourth functional element 4 is, for example, a volume adjustment knob, and includes a body 41, a plurality of fixing portions 42, and an electrical interface 43. The fixing portions 42 and the electrical interface 43 are fixedly connected to the body 41. Each fixing portion 42 is, for example, a magnet, a magnetic attracting member, a compression expansion member, or a latch, and the electrical interface 43 is, for example, a USB-compatible interface.

The fourth functional element 4 can be secured to any one of the fourth mounting region R4, the fifth mounting region R5, the sixth mounting region R6, the eighth mounting region R8, the ninth mounting region R9, and the tenth mounting region R10 of the supporting base 7 via magnetic forces, gravity, or snap-fitting forces. When the fourth functional element 4 is secured to the eighth mounting region R8, the positions of the plurality of fixing portions 42 of the fourth functional element 4 correspond to the positions of the plurality of fixing portions 73 located in the eighth mounting region R8, and the electrical interface 43 of the fourth functional element 4 contacts the electrical interface 74 located in the eighth mounting region R8, thereby establishing an electrical connection between the fourth functional element 4 and the supporting base 7. In other embodiments, when the position of at least one of the fixing portions 42 of the fourth functional element 4 corresponds to one of the fixing portions 73 located in the eighth mounting region R8, the fourth functional element 4 can be fixed to the supporting base 7.

The fifth functional element 5 is, for example, a microphone adjustment knob, and includes a body 51, a plurality of fixing portions 52, and an electrical interface 53. The fixing portions 52 and the electrical interface 53 are fixedly connected to the body 51. Each fixing portion 52 is, for example, a magnet, a magnetic attracting member, a compression expansion member, or a latch, and the electrical interface 53 is, for example, a USB-compatible interface.

The fifth functional element 5 can be secured to any one of the fourth to tenth mounting regions R4 to R10 of the supporting base 7 through magnetic forces, gravity, or snap-fitting forces. When the fifth functional element 5 is secured to the ninth mounting region R9, the positions of the plurality of fixing portions 52 of the fifth functional element 5 correspond to the positions of the plurality of fixing portions 73 located in the ninth mounting region R9, and the electrical interface 53 of the fifth functional element 5 contacts the electrical interface 74 located in the ninth mounting region R9, thereby establishing an electrical connection between the fifth functional element 5 and the supporting base 7. In other embodiments, when the position of at least one of the fixing portions 52 of the fifth functional element 5 corresponds to one of the fixing portions 73 located in the ninth mounting region R9, the fifth functional element 5 can be fixed to the supporting base 7.

The sixth functional element 6 is, for example, a brightness adjustment knob, and includes a body 61, a plurality of fixing portions 62, and an electrical interface 63. The fixing portions 62 and the electrical interface 63 are fixedly connected to the body 61. Each fixing portion 62 is, for example, a magnet, a magnetic attracting member, a compression expansion member, or a latch, and the electrical interface 63 is, for example, a USB-compatible interface.

The sixth functional element 6 can be secured to any one of the fourth mounting region R4 to the tenth mounting region R10 of the supporting base 7 through magnetic forces, gravity, or snap-fitting forces. When the sixth functional element 6 is secured to the tenth mounting region R10, the positions of the fixing portions 62 of the sixth functional element 6 correspond to the positions of the fixing portions 73 located in the tenth mounting region R10, and the electrical interface 63 of the sixth functional element 6 contacts the electrical interface 74 located in the tenth mounting region R10, thereby establishing an electrical connection between the sixth functional element 6 and the supporting base 7. In other embodiments, when the position of at least one of the fixing portions 62 of the sixth functional element 6 corresponds to the position of one of the fixing portions 73 located in the tenth mounting region R10, the sixth functional element 6 can be fixed to the supporting base 7.

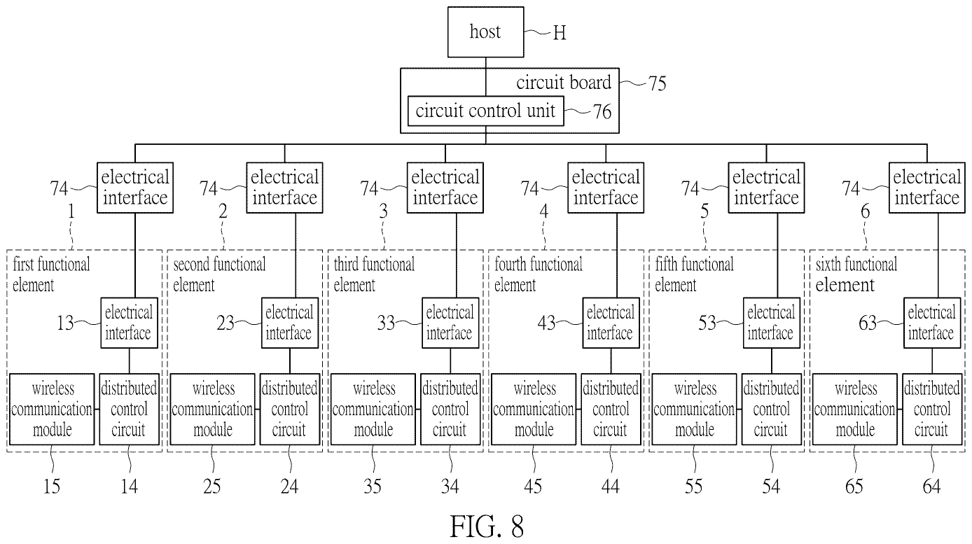

FIG. 8 is a topological diagram of telecommunication connections of the interactive device of FIG. 4. Referring to FIG. 8, the supporting base 7 further includes a circuit board 75 and a circuit control unit 76, and the circuit control unit 76 is disposed on the circuit board 75. The plurality of electrical interfaces 74 electrically connect to the circuit board 75. The circuit control unit 76 is electrically connected to the plurality of electrical interfaces 74. The circuit control unit 76 is connected to one end of a transmission line, and the other end of the transmission line is connected to a host H, such as a computer.

The distributed control circuit 14 of the first functional element 1 is electrically connected to the electrical interface 13, the electrical interface 13 is electrically connected to the electrical interface 74 of the supporting base 7, and the electrical interface 74 is electrically connected to the circuit control unit 76. When a user operates the first functional element 1, the distributed control circuit 14 of the first functional element 1 generates and outputs a first input signal, first type information, and first position information. The first input signal, the first type information, and the first position information are transmitted to the circuit control unit 76 via the electrical interface 13 and the electrical interface 74.

The circuit control unit 76 determines that the first functional element 1 is a physical keyboard based on the first type information, and knows the mounting region of the supporting base 7 on which the first functional element 1 is disposed based on the first position information. The circuit control unit 76 then transmits the first input signal, the first type information, and the first position information to the host H. The host H executes a function corresponding to the first input signal.

The second functional element 2 further includes a distributed control circuit 24 and a wireless communication module 25. The distributed control circuit 24 is electrically connected to the wireless communication module 25 and the electrical interface 23. The electrical interface 23 is electrically connected to the electrical interface 74 of the supporting base 7, and the electrical interface 74 is electrically connected to the circuit control unit 76. When a user operates the second functional element 2, the distributed control circuit 24 of the second functional element 2 generates and outputs a second input signal, second type information, and second position information. The second input signal, the second type information, and the second position information are transmitted to the circuit control unit 76 via the electrical interface 23 and the electrical interface 74.

The circuit control unit 76 knows that the second functional element 2 is a special function keyboard based on the second type information, and knows the mounting region of the supporting base 7 on which the second functional element 2 is located based on the second position information. The circuit control unit 76 then transmits the second input signal, the second type information, and the second position information to the host H. The host H executes a function corresponding to the second input signal.

The wireless communication module 25 of the second functional element 2 has a sleep state and an active state. The distributed control circuit 24 switches the wireless communication module 25 between the sleep state and the active state according to preset conditions, so as to achieve power conservation. When being in the active state, the wireless communication module 25 wirelessly pairs with the host H.

The functional element 3 further includes a distributed control circuit 34 and a wireless communication module 35. The distributed control circuit 34 is electrically connected to the wireless communication module 35 and the electrical interface 33. The electrical interface 33 is electrically connected to the electrical interface 74 of the supporting base 7, and the electrical interface 74 is electrically connected to the circuit control unit 76. When a user operates the third functional element 3, the distributed control circuit 34 of the third functional element 3 generates and outputs a third input signal, third type information, and third position information. The third input signal, the third type information, and the third position information are transmitted to the circuit control unit 76 via the electrical interface 33 and the electrical interface 74.

The circuit control unit 76 knows that the third functional element 3 is a touch screen based on the third type information, and knows the mounting region of the supporting base 7 on which the third functional element 3 is located based on the third position information. The circuit control unit 76 then transmits the third input signal, the third type information, and the third position information to the host H. The host H executes a function corresponding to the third input signal.

The wireless communication module 35 of the third functional element 3 has a sleep state and an active state. The distributed control circuit 34 switches the wireless communication module 35 between the sleep state and the active state according to preset conditions, so as to achieve power conservation. When being in the active state, the wireless communication module 35 wirelessly pairs with the host H.

The fourth functional element 4 further includes a distributed control circuit 44 and a wireless communication module 45. The distributed control circuit 44 is electrically connected to the wireless communication module 45 and the electrical interface 43. The electrical interface 43 is electrically connected to the electrical interface 74 of the supporting base 7, and the electrical interface 74 is electrically connected to the circuit control unit 76. When a user operates the fourth functional element 4, the distributed control circuit 44 of the fourth functional element 4 generates and outputs a fourth input signal, fourth type information, and fourth position information. The fourth input signal, the fourth type information, and the fourth position information are transmitted to the circuit control unit 76 via the electrical interface 43 and the electrical interface 74.

The circuit control unit 76 knows that the fourth functional element 4 is a volume adjustment knob based on the fourth type information, and knows the mounting region of the supporting base 7 on which the fourth functional element 4 is located based on the fourth position information. The circuit control unit 76 then transmits the fourth input signal, the fourth type information, and the fourth position information to the host H. The host H executes a function corresponding to the fourth input signal.

The wireless communication module 45 of the fourth functional element 4 has a sleep state and an active state. The distributed control circuit 44 switches the wireless communication module 45 between the sleep state and the active state according to preset conditions, so as to achieve power conservation. When being in the active state, the wireless communication module 45 wirelessly pairs with the host H.

The fifth functional element 5 further includes a distributed control circuit 54 and a wireless communication module 55. The distributed control circuit 54 is electrically connected to the wireless communication module 55 and the electrical interface 53. The electrical interface 53 is electrically connected to the electrical interface 74 of the supporting base 7, and the electrical interface 74 is electrically connected to the circuit control unit 76. When a user operates the fifth functional element 5, the distributed control circuit 54 of the fifth functional element 5 generates and outputs a fifth input signal, fifth type information, and fifth position information. The fifth input signal, the fifth type information, and the fifth position information are transmitted to the circuit control unit 76 via the electrical interface 53 and the electrical interface 74.

The circuit control unit 76 knows that the fifth functional element 5 is a microphone adjustment knob based on the fifth type information, and knows the mounting region of the supporting base 7 on which the fifth functional element 5 is located based on the fifth position information. The circuit control unit 76 then transmits the fifth input signal, the fifth type information, and the fifth position information to the host H. The host H executes a function corresponding to the fifth input signal.

The wireless communication module 55 of the fifth functional element 5 has a sleep state and an active state. The distributed control circuit 54 switches the wireless communication module 55 between the sleep state and the active state according to preset conditions, so as to achieve power conservation. When being in the active state, the wireless communication module 55 wirelessly pairs with the host H.

The sixth functional element 6 further includes a distributed control circuit 64 and a wireless communication module 65. The distributed control circuit 64 is electrically connected to the wireless communication module 65 and the electrical interface 63. The electrical interface 63 is electrically connected to the electrical interface 74 of the supporting base 7, and the electrical interface 74 is electrically connected to the circuit control unit 76. When a user operates the sixth functional element 6, the distributed control circuit 64 of the sixth functional element 6 generates and outputs a sixth input signal, sixth type information, and sixth position information. The sixth input signal, the sixth type information, and the sixth position information are transmitted to the circuit control unit 76 via the electrical interface 63 and the electrical interface 74.

The circuit control unit 76 knows that the sixth functional element 6 is a brightness adjustment knob based on the sixth type information, and knows the mounting region of the supporting base 7 on which the sixth functional element 6 is located based on the sixth position information. The circuit control unit 76 then transmits the sixth input signal, the sixth type information, and the sixth position information to the host H. The host H executes a function corresponding to the sixth input signal.

The wireless communication module 65 of the sixth functional element 6 has a sleep state and an active state. The distributed control circuit 64 switches the wireless communication module 65 between the sleep state and the active state according to preset conditions, so as to achieve power conservation. When being in the active state, the wireless communication module 65 wirelessly pairs with the host H.

The circuit control unit 76 includes a priority table, and the priority table includes user-defined priority levels for the first to sixth functional elements 1 to 6. For example, the highest to lowest priority levels are sequentially for the first to sixth functional elements 6. When the circuit control unit 76 simultaneously receives the first input signal from the first functional element 1 and the second input signal from the second functional element 2, the circuit control unit 76 prioritizes transmission of the first input signal to the host H, and then transmits the second input signal to the host H.

When a user is a right-handed person, the functional elements that are frequently used by the user can be mounted on a left side of the supporting base 7. When a user is a left-handed person, the functional elements that are frequently used by the user can be mounted on a right side of the supporting base 7. Therefore, the functional elements are suitable for different types of users, and the users can operate the functional elements conveniently. Since each functional element has both wired and wireless operation modes and each user can set a priority of the functional elements, the user can select an appropriate operation mode and set the priority of the functional elements based on their work environment and task type.

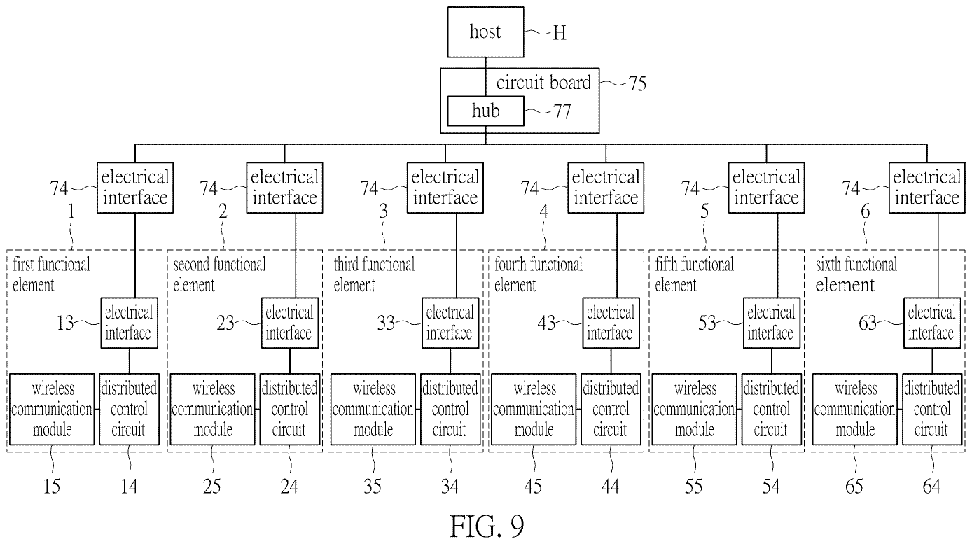

FIG. 9 is a topological diagram of the telecommunication connections of the interactive device according to a second embodiment of the present disclosure. Comparing FIG. 9 with FIG. 8, their differences are described below. The circuit board 75 of the supporting base 7 does not include the circuit control unit 76, but includes a hub 77. The hub 77 is electrically connected to the electrical interfaces 74 of the supporting base 7. The hub 77 is also connected to one end of a transmission line, and the other end of the transmission line is connected to the host H. In this embodiment, the hub 77 is a universal serial bus (USB) hub.

The distributed control circuit 14 of the first functional element 1 is electrically connected to the electrical interface 13. The electrical interface 13 of the first functional element 1 is electrically connected to the electrical interface 74 of the supporting base 7. The electrical interface 74 is further electrically connected to the hub 77 of the supporting base 7. When a user operates the first functional element 1, the distributed control circuit 14 of the first functional element 1 generates and outputs a first input signal, first type information, and first position information. The first input signal, the first type information, and the first position information are transmitted to the hub 77 via the electrical interface 13 and the electrical interface 74. The hub 77 then transmits the first input signal, the first type information, and the first position information to the host H.

The distributed control circuit 24 of the second functional element 2 is electrically connected to the electrical interface 23. The electrical interface 23 of the second functional element 2 is electrically connected to the electrical interface 74 of the supporting base 7. The electrical interface 74 is further electrically connected to the hub 77 of the supporting base 7. When a user operates the second functional element 2, the distributed control circuit 24 of the second functional element 2 generates and outputs a second input signal, second type information, and second position information. The second input signal, the second type information, and the second position information are transmitted to the hub 77 via the electrical interface 23 and the electrical interface 74. The hub 77 then transmits the second input signal, the second type information, and the second position information to the host H.

The distributed control circuit 34 of the third functional element 3 is electrically connected to the electrical interface 33, and the electrical interface 33 is electrically connected to the electrical interface 74 of the supporting base 7. The electrical interface 74 is electrically connected to the hub 77 of the supporting base 7. When a user operates the third functional element 3, the distributed control circuit 34 of the third functional element 3 generates and outputs a third input signal, third type information, and third position information. The third input signal, the third type information, and the third position information are transmitted to the hub 77 via the electrical interface 33 and the electrical interface 74. The hub 77 then transmits the third input signal, the third type information, and the third position information to the host H.

The distributed control circuit 44 of the fourth functional element 4 is electrically connected to the electrical interface 43, and the electrical interface 43 is electrically connected to the electrical interface 74 of the supporting base 7. The electrical interface 74 is electrically connected to the hub 77. When a user operates the fourth functional element 4, the distributed control circuit 44 of the fourth functional element 4 generates and outputs a fourth input signal, fourth type information, and fourth position information. The fourth input signal, the fourth type information, and the fourth position information are transmitted to the hub 77 via the electrical interface 43 and the electrical interface 74. The hub 77 then transmits the fourth input signal, the fourth type information, and the fourth position information to the host H.

The distributed control circuit 54 of the fifth functional element 5 is electrically connected to the electrical interface 53, and the electrical interface 53 is further electrically connected to the electrical interface 74 of the supporting base 7. The electrical interface 74 is electrically connected to the hub 77. When a user operates the fifth functional element 5, the distributed control circuit 54 of the fifth functional element 5 generates and outputs a fifth input signal, fifth type information, and fifth position information. The fifth input signal, the fifth type information, and the fifth position information are transmitted to the hub 77 via the electrical interface 53 and the electrical interface 74. The hub 77 then transmits the fifth input signal, the fifth type information, and the fifth position information to the host H.

The distributed control circuit 64 of the sixth functional element 6 is electrically connected to the electrical interface 63, and the electrical interface 63 is electrically connected to the electrical interface 74 of the supporting base 7. This electrical interface 74 is electrically connected to the hub 77. When a user operates the sixth functional element 6, the distributed control circuit 64 of the sixth functional element 6 generates and outputs a sixth input signal, sixth type information, and sixth position information. The sixth input signal, the sixth type information, and the sixth position information are transmitted to the hub 77 via the electrical interface 63 and the electrical interface 74. The hub 77 then transmits the sixth input signal, the sixth type information, and the sixth position information to the host H.

The host H is equipped with an operating interface. When a functional element sends an input signal to the host H, the operating interface displays type information and location information of the functional element. Since a user can know a type and a location of the functional element through the operating interface of the host H, it is convenient for the user to replace different functional elements and adjust their positions according to work needs.

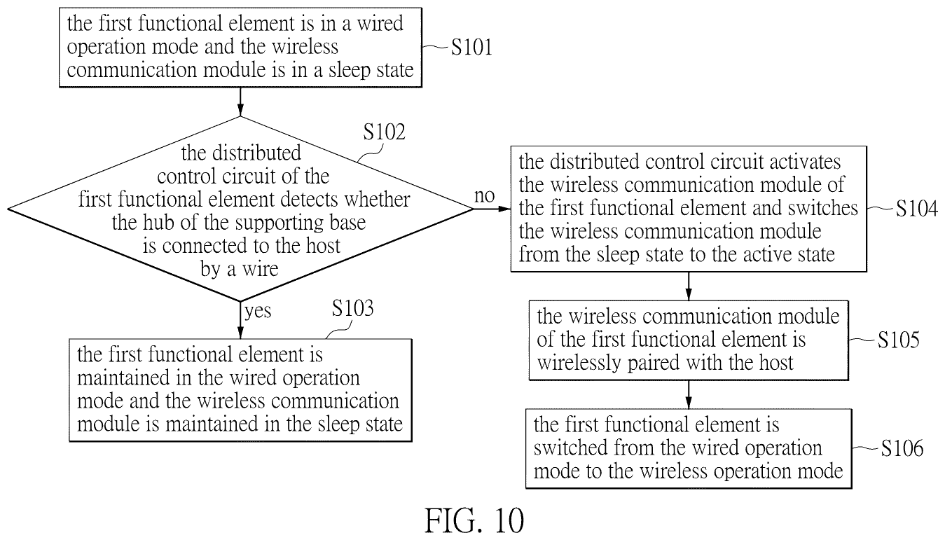

FIG. 10 is a flow chart of a control method of the interactive device according to the first embodiment of the present disclosure. Referring to FIG. 10, in step S101, the first functional element 1 is in a wired operation mode, and the wireless communication module 15 is in a sleep state.

In step S102, the distributed control circuit 14 of the first functional element 1 detects whether or not the hub 77 of the supporting base 7 is connected to the host H by a wire.

When the hub 77 is connected to the host H by the wire, the control method proceeds to step S103.

When the hub 77 is not connected to the host H by the wire, the control method proceeds to step S104.

In step S103, the first functional element 1 is maintained in the wired operation mode, and the wireless communication module 15 is maintained in the sleep state.

In step S104, the distributed control circuit 14 activates the wireless communication module 15 of the first functional element 1, and switches the wireless communication module 15 from the sleep state to the active state. After step S104, the control method proceeds to step S105.

In step S105, the wireless communication module 15 of the first functional element 1 is wirelessly paired with the host H. After step S105, the control method proceeds to step S106.

In step S106, the first functional element 1 is switched from the wired operation mode to the wireless operation mode.

Similarly, the control method of FIG. 10 is also applicable to the second functional element 2 to the sixth functional element 6.

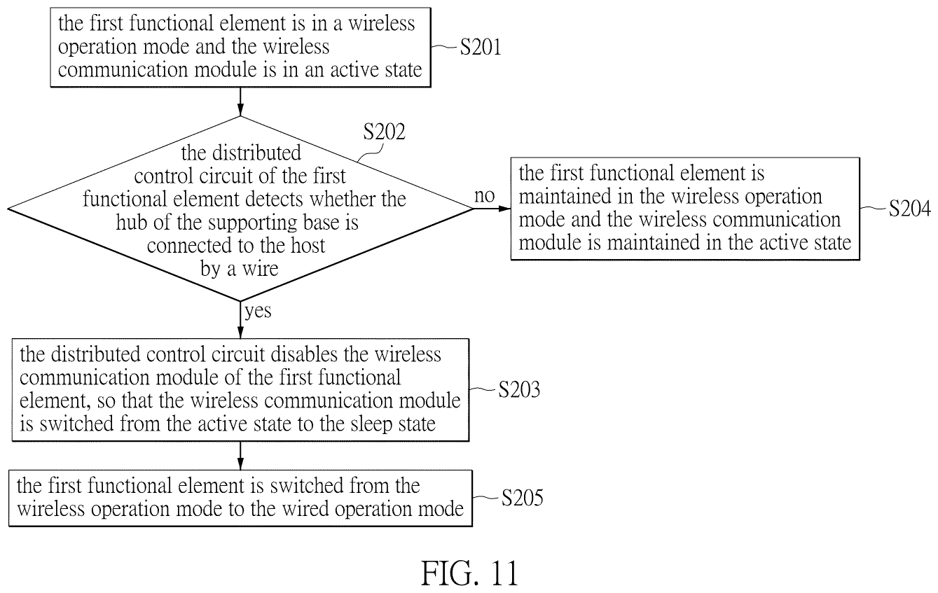

FIG. 11 is a flow chart of the control method of the interactive device according to the second embodiment of the present disclosure. Referring to FIG. 11, in step S201, the first functional element 1 is in a wireless operation mode, and the wireless communication module 15 is in an active state.

In step S202, the distributed control circuit 14 of the first functional element 1 detects whether or not the hub 77 of the supporting base 7 is connected to the host H by a wire.

When the hub 77 is connected to the host H by the wire, the control method proceeds to step S203.

When the hub 77 is not connected to the host H by the wire, the control method proceeds to step S204.

In step S203, the distributed control circuit 14 disables the wireless communication module 15 of the first functional element 1, so that the wireless communication module 15 is switched from the active state to the sleep state.

In step S204, the first functional element 1 is maintained in the wireless operation mode, and the wireless communication module 15 is maintained in the active state.

After step S203, the control method proceeds to step S205.

In step S205, the first functional element 1 is switched from the wireless operation mode to the wired operation mode.

Similarly, the control method of FIG. 11 is also applicable to the second functional element 2 to the sixth functional element 6.

After a user operates the first functional element 1 in the wired operation mode, if a transmission line connected to the first functional element 1 is immediately unplugged by the user, an input signal generated by the first functional element 1 is temporarily stored in a register of the first functional element 1. When the first functional element 1 is switched from the wired operation mode to the wireless operation mode, the first functional element 1 in the wireless operation mode transmits the input signal to the host H.

After a user operates the first functional element 1 in the wireless operation mode, if the user immediately connects two ends of the transmission line respectively to the host H and the first functional element 1, the input signal generated by the first functional element 1 is temporarily stored in the register of the first functional element 1. When the first functional element 1 is switched from the wireless operation mode to the wired operation mode, the first functional element 1 in the wired operation mode transmits the input signal to the host H through the transmission line.

The above technical means of temporarily storing the input signal in the register is also applicable to the second functional element 2 to the sixth functional element 6.

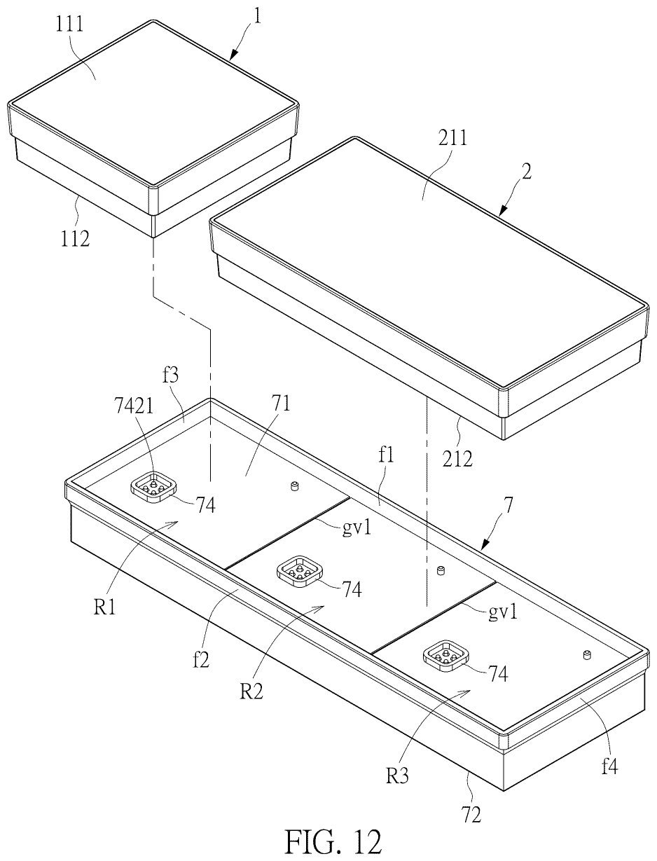

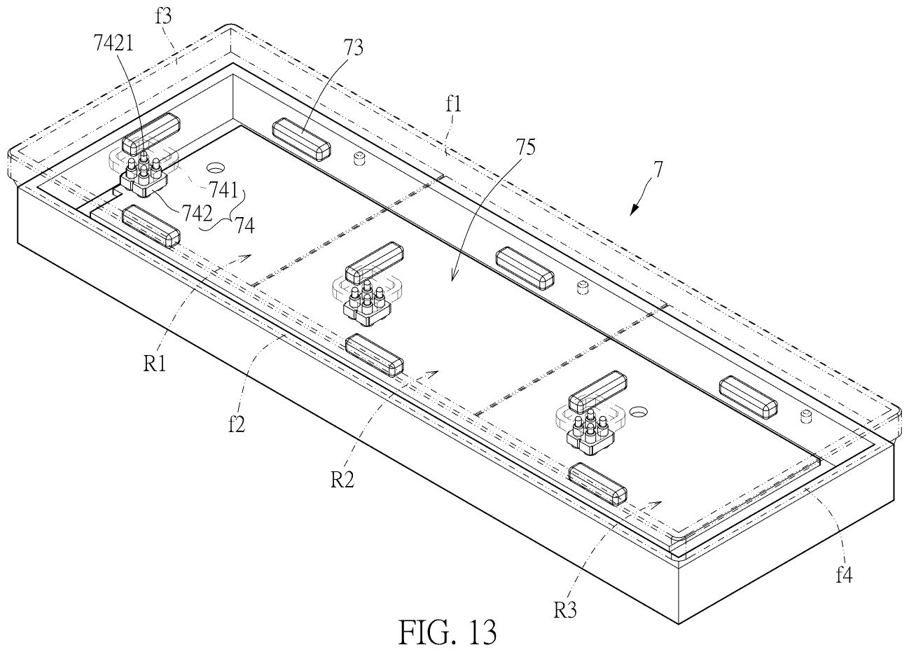

FIG. 12 is a schematic exploded view of the interactive device according to a third embodiment of the present disclosure, and FIG. 13 is a schematic perspective view of a supporting base of the interactive device of FIG. 12. Referring to FIG. 12, the supporting surface 71 includes the first mounting region R1, the second mounting region R2, and the third mounting region R3, and the first mounting region R1, the second mounting region R2, and the third mounting region R3 have the same area. The body 11 of the first functional element 1 includes a first functional surface 111 and a first mounting surface 112, and the first mounting surface 112 is disposed on one of the first mounting region R1, the second mounting region R2, and the third mounting region R3. The body 21 of the second functional element 2 includes a second functional surface 211 and a second mounting surface 212, and the second mounting surface 212 is disposed on any other two adjacent ones of the first mounting region R1, the second mounting region R2, and the third mounting region R3.

Specifically, when the first functional element 1 is detachably disposed on the first mounting region R1, the second functional element 2 is detachably disposed on the second mounting region R2 and the third mounting region R3. When the first functional element 1 is detachably disposed on the third mounting region R3, the second functional element 2 is detachably disposed on the first mounting region R1 and the second mounting region R2.

The plurality of electrical interfaces 74 are respectively provided in the first mounting region R1, the second mounting region R2, and the third mounting region R3. Referring to FIG. 13, each electrical interface 74 includes a positioning portion 741 and an electrode portion 742, and each electrode portion 742 includes a plurality of electrical terminals 7421. The positioning portion 741 of the electrical interface 74 in the first mounting region R1 allows the first functional element 1 to be mounted on the supporting base 7, so that the first functional element 1 is electrically connected to the electrode portion 742. The positioning portions 741 of the plurality of electrical interfaces 74 in the second mounting region R2 and the third mounting region R3 allow the second functional element 2 to be mounted on the supporting base 7, so that the second functional element 2 is electrically connected to the plurality of electrode portions 742.

Referring to FIG. 12, the supporting base 7 further has a plurality of side surfaces f1 to f4 and a plurality of first partitioning grooves gv1 formed thereon. The plurality of side surfaces fs1 to fs4 are formed around the outermost perimeter of the first mounting region R1, the second mounting region R2 and the third mounting region R3. Extension lines of both endpoints of the at least one first partitioning groove gv1 intersect with any two of the plurality of side surfaces f1 to f4 that are opposite to each other relative to the supporting surface 71 For example, the extension lines of both endpoints of each first partitioning groove gv1 intersect with the side surfaces fs1 to fs2, or the both endpoints of each first partitioning groove gv1 intersect with the side surfaces fs1 to fs2. In this embodiment, the two endpoints of each first partitioning groove gv1 intersect with the side surfaces fs1 to fs2.

Specifically, on the basis of the supporting base 7 and the first functional element 1 and the second functional element 2 being all parallel to each other and being equidistant from each other, a projected area of the second functional element 2 relative to the supporting base 7 is greater than or equal to a projected area of the first functional element 1 relative to the supporting base 7. Here, the actual structural volume difference or function difference between the first functional element 1 and the second functional element 2 is irrelevant, and only the actual area of the functional element that is detachably disposed on the supporting base 7 is concerned.

Referring to FIGS. 12 and 13, an internal space is formed between the supporting surface 71 and the bottom surface 72 of the supporting base 7. The circuit board 75 is disposed within the receiving space. Each of the first mounting region R1, the second mounting region R2, and the third mounting region R3 is provided with the plurality of fixing portions 73. The fixing portions 73 in the first mounting region R1 are used to secure the first functional element 1 to the first mounting region R1 of the supporting base 7. The fixing portions 73 in the second and third mounting regions R2 and R3 are used to secure the second functional element 2 to the second and third mounting regions R2 and R3 of the supporting base 7. Each fixing portion 73 includes a magnetic element.

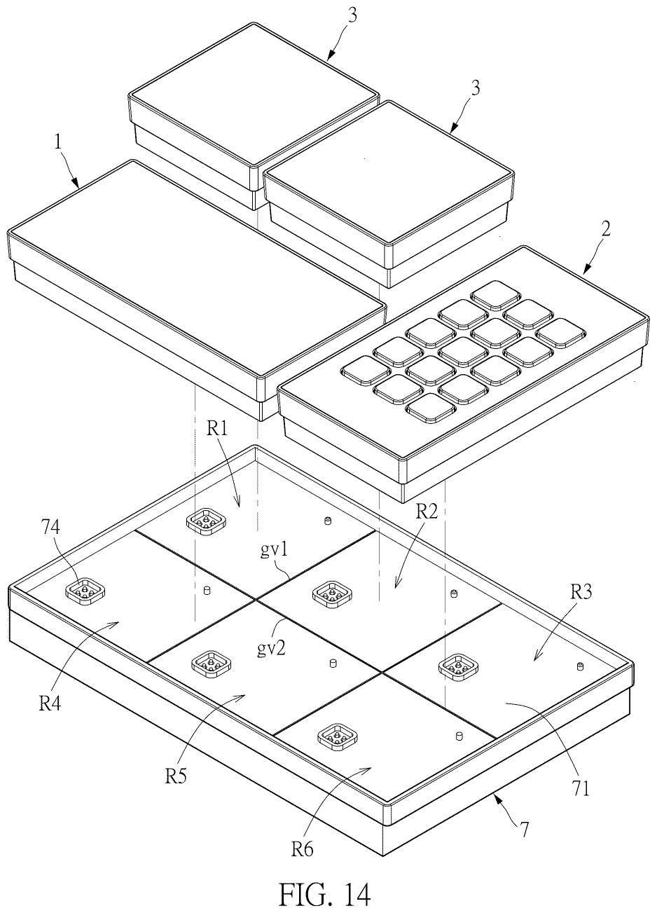

FIG. 14 is a schematic exploded view of the interactive device according to a fourth embodiment of the present disclosure. Referring to FIG. 14, the supporting surface 71 of the supporting base 7 includes the plurality of first partitioning grooves gv1 formed thereon and a second partitioning groove gv2 formed thereon. The extension lines of the both endpoints of each first partitioning groove gv1 intersect with the side surfaces fs1 to fs2, or the both endpoints of each first partitioning groove gv1 intersect with the side surfaces fs1 to fs2. Extension lines of both endpoints of the second partitioning groove gv2 intersect perpendicularly with the extension lines of the plurality of first partitioning grooves gv1, or the second partitioning groove gv2 intersects perpendicularly with the plurality of first partitioning grooves gv1.

In this embodiment, the both endpoints of each first partitioning groove gv1 respectively intersect with the side surfaces fs1 to fs2, and the second partitioning groove gv2 intersects perpendicularly with the first partitioning grooves gv1, so that the first mounting region R1, the second mounting region R2, the third mounting region R3, the fourth mounting region R4, the fifth mounting region R5, and the sixth mounting region R6 are formed on the supporting surface 71.

The first mounting region R1, the second mounting region R2, the third mounting region R3, the fourth mounting region R4, the fifth mounting region R5, and the sixth mounting region R6 have the same area. The first functional element 1 can be detachably disposed on the fourth mounting region R4 and the fifth mounting region R5. The second functional element 2 can be detachably disposed on the third mounting region R3 and the sixth mounting region R6. The plurality of third functional elements 3 can be detachably disposed on the first mounting region R1 and the second mounting region R2.

Specifically, when the supporting base 7, the first functional element 1, the second functional element 2, and the plurality of third functional elements 3 are all parallel to each other and are equidistant from each other, a projected area of each third functional element 3 relative to the supporting base 7 is less than or equal to the projected area of the first functional element 1 relative to the supporting base 7 or the projected area of the second functional element 2 relative to the supporting base 7. Here, the actual structural volume difference or function difference between the first functional element 1, the second functional element 2, and the plurality of third functional elements 3 is irrelevant, and only the actual area of the functional element detachably disposed on the supporting base 7 is concerned.

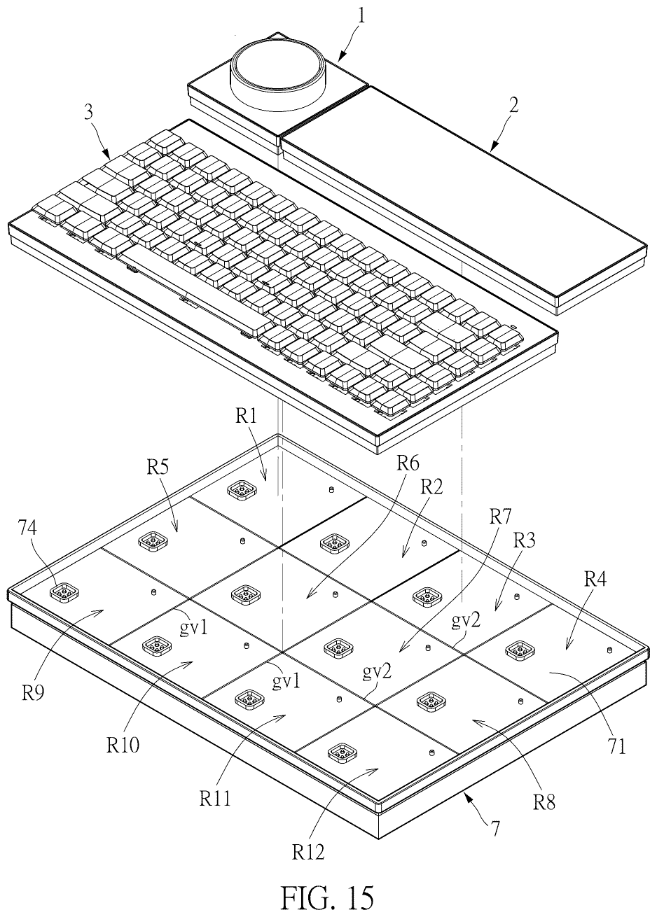

FIG. 15 is a schematic exploded view of the interactive device according to a fifth embodiment of the present disclosure. Referring to FIG. 15, the supporting surface 71 of the supporting base 7 includes the plurality of first partitioning grooves gv1 and the plurality of second partitioning grooves gv2. The both endpoints of each first partitioning groove gv1 intersect with the side surfaces fs1 to fs2, and each second partitioning groove gv2 intersects perpendicularly with the plurality of first partitioning grooves gv1, so that the first mounting region R1, the second mounting region R2, the third mounting region R3, the fourth mounting region R4, the fifth mounting region R5, the sixth mounting region R6, the seventh mounting region R7, the eighth mounting region R8, the ninth mounting region R9, the tenth mounting region R10, an eleventh mounting region R11, and a twelfth mounting region R12 are formed on the supporting surface 71.

The first mounting region R1, the second mounting region R2, the third mounting region R3, the fourth mounting region R4, the fifth mounting region R5, the sixth mounting region R6, the seventh mounting region R7, the eighth mounting region R8, the ninth mounting region R9, the tenth mounting region R10, the eleventh mounting region R11, and the twelfth mounting region R12 have the same area. The first functional element 1 can be detachably disposed on the first mounting region R1, the second functional element 2 can be detachably disposed on the second mounting region R2, the third mounting region R3, and the fourth mounting region R4, and the third functional element 3 can be detachably disposed on the fifth mounting region R5, the sixth mounting region R6, the seventh mounting region R7, the eighth mounting region R8, the ninth mounting region R9, the tenth mounting region R10, the eleventh mounting region R11, and the twelfth mounting region R12.

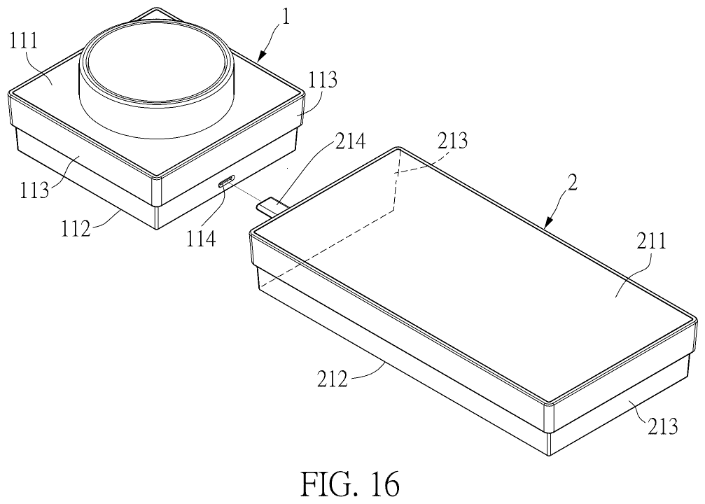

FIG. 16 is a schematic exploded view of the interactive device according to a sixth embodiment of the present disclosure. The body 11 of the first functional element 1 includes a first functional surface 111, a first mounting surface 112 opposite to the first functional surface 111, and a plurality of first side surfaces 113 that surround the first functional surface 111 and the first mounting surface 112. One of the plurality of first side surfaces 113 is provided with a connecting slot 114. The connecting slot 114 of the first functional element 1 can be connected to a side connector 214 of the second functional element 2.

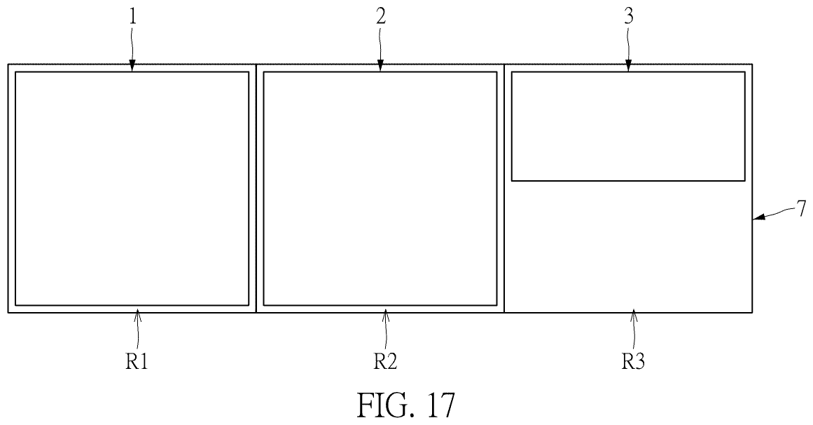

FIG. 17 is a schematic planar view of the interactive device according to a seventh embodiment of the present disclosure. The interactive device includes the first functional element 1, the second functional element 2, the third functional element 3, and the supporting base 7. The supporting base 7 includes the first mounting region R1, the second mounting region R2, and the third mounting region R3. The first functional element 1 and the second functional element 2 are respectively disposed on the first mounting region R1 and the second mounting region R2, while the third functional element 3 is disposed on a portion of the third mounting region R3.

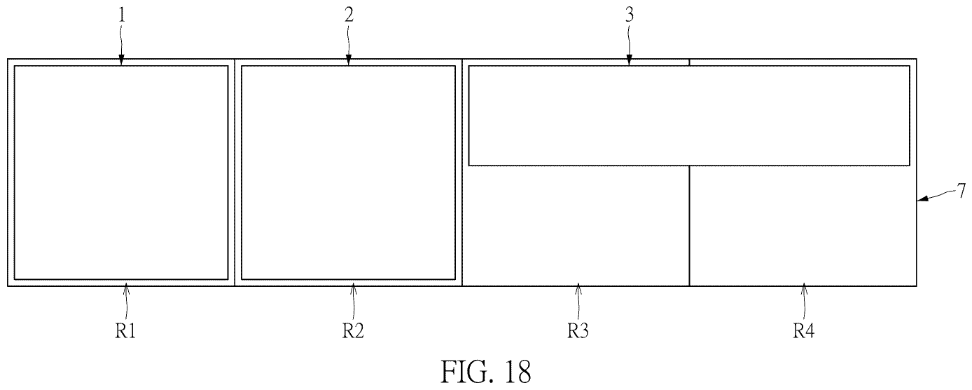

FIG. 18 is a schematic planar view of the interactive device according to an eighth embodiment of the present disclosure. The interactive device includes the first functional element 1, the second functional element 2, the third functional element 3, and the supporting base 7. The supporting base 7 includes the first mounting region R1, the second mounting region R2, the third mounting region R3, and the fourth mounting region R4. The first functional element 1 and the second functional element 2 are respectively disposed on the first mounting region R1 and the second mounting region R2, while the third functional element 3 is disposed on a portion of the third mounting region R3 and a portion of the fourth mounting region R4.

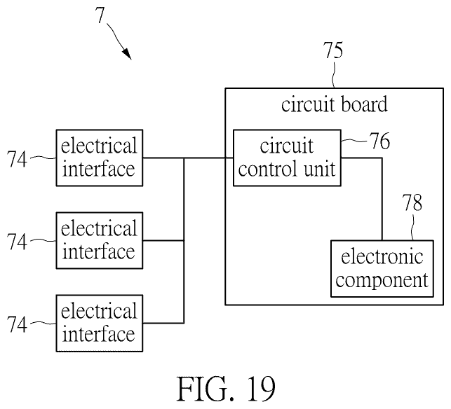

FIG. 19 is a functional block diagram of a circuit architecture of the supporting base of the interactive device according to one embodiment of the present disclosure. The supporting base 7 includes the plurality of electrical interfaces 74, the circuit board 75, the circuit control unit 76, and an electronic component 78. The electronic component 78 is disposed in the internal space of the supporting base 7. The circuit control unit 76 and the electronic component 78 are disposed on the circuit board 75. The circuit control unit 76 is in direct or indirect electrical connection with each of the plurality of electrical interfaces 74. The electronic component 78 is electrically connected to the circuit control unit 76. The electronic component 78 is selected from one of a central processing unit, a bus control unit, a wireless communication unit, a microprocessor unit, a graphics processing unit, a digital signal processing unit, and a memory.

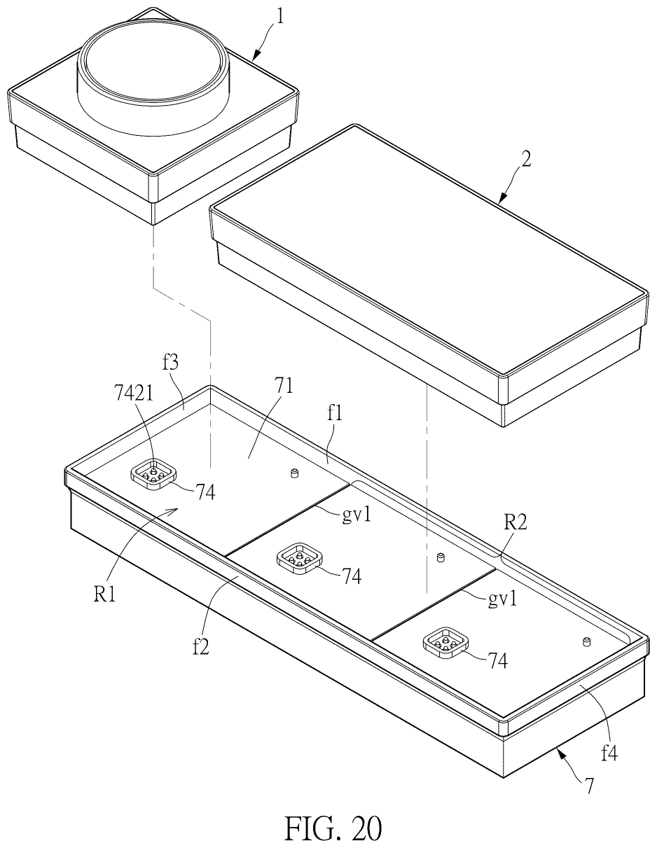

FIG. 20 is a schematic diagram of the interactive device in a first configuration according to the third embodiment of the present disclosure. The interactive device includes the supporting base 7, the first functional element 1, and the second functional element 2. The supporting surface 71 of the supporting base 7 is provided with the plurality of electrical interfaces 74, and the supporting surface 71 further includes the first mounting region R1 and the second mounting region R2. The first mounting region R1 has a first area, the second mounting region R2 has a second area, and the second area is larger than the first area.

The first functional element 1 is detachably disposed on the first mounting region R1 of the supporting surface 71, and is electrically connected to the electrical interface 74 in the first mounting region R1. The second functional element 2 is detachably disposed on the second mounting region R2 of the supporting surface 71, and is electrically connected to at least one of the plurality of electrical interfaces 74 in the second mounting region R2.

When the first functional element 1 is disposed on the first mounting region R1 and the second functional element 2 is disposed on the second mounting region R2, the interactive device is formed into a first configuration.

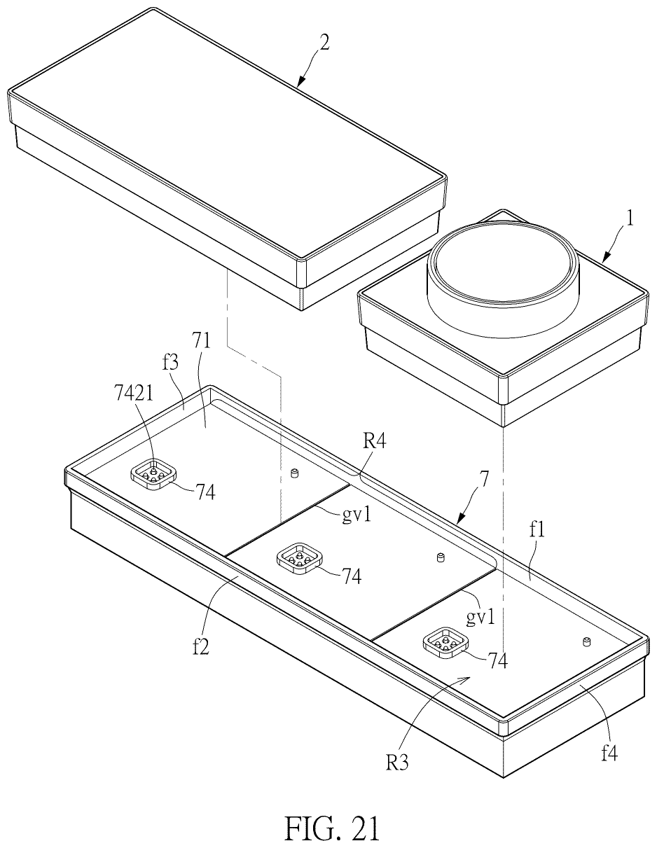

FIG. 21 is a schematic diagram of the interactive device in a second configuration according to the third embodiment of the present disclosure.

The interactive device includes the supporting base 7, the first functional element 1, and the second functional element 2. The supporting surface 71 of the supporting base 7 is provided with the plurality of electrical interfaces 74, and the supporting surface 71 further includes the third mounting region R3 and the fourth mounting region R4. The third mounting region R3 has a first area, the fourth mounting region R4 has a second area, and the second area is larger than the first area.

The first functional element 1 is detachably disposed on the third mounting region R3, and is electrically connected to the electrical interface 74 in the third mounting region R3. The second functional element 2 is detachably disposed on the fourth mounting region R4 of the supporting surface 71, and is electrically connected to at least one of the plurality of electrical interfaces 74 in the fourth mounting region R4.

When the first functional element 1 is disposed on the third mounting region R3 and the second functional element 2 is disposed on the fourth mounting region R4, the interactive device is formed into a second configuration.

For example, the second functional element 2 is a keyboard, the first configuration is suitable for right-handed users, and the second configuration is suitable for left-handed users.

### Beneficial Effects of the Embodiments

In conclusion, in the interactive device provided by the present disclosure, each functional element is removably secured to the supporting base, thereby allowing users to adjust the position of the functional element according to their dominant hand and improving operational convenience. Since each functional element has the wired operation mode (i.e., an actual electrical connection for signal transmission) and the wireless operation mode, the users can select one of the two operation modes based on their working environment and type of work. When the functional element is in the wired operation mode, the wireless communication module is automatically disabled to achieve an effect of saving power. When the wired and wireless operation modes are being switched, the input signal of the functional element is temporarily stored in the register, so as to prevent malfunction in which the input signal is not transmitted to the host.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An interactive device, comprising:
a supporting base comprising a supporting surface, a bottom surface and an internal space formed between the supporting surface and the bottom surface, wherein the supporting surface further comprising a plurality of mounting regions;
a first functional element comprising a first functional surface and a first mounting surface being disposed on at least one of the plurality of mounting regions; and
a second functional element comprising a second functional surface and a second mounting surface being disposed on at least another one of the plurality of mounting regions.

2. The interactive device according to claim 1, wherein the second functional element is further disposed on at least two adjacent ones of the plurality of mounting regions.

3. The interactive device according to claim 1, wherein each of the plurality of mounting regions comprises at least one fixing portion for fixing the first functional element or/and the second functional element on the supporting base.

4. The interactive device according to claim 3, wherein the fixing portion is magnet or ferromagnetic.

5. The interactive device according to claim 1, wherein the supporting base further comprises a plurality of side surfaces formed around the outermost perimeter of the plurality of mounting regions.

6. The interactive device according to claim 5, wherein the supporting surface further comprises at least one first partitioning groove formed thereon, wherein the extension lines of both endpoints of the at least one first partitioning groove intersect with any two of the plurality of side surfaces that are opposite to each other relative to the supporting surface.

7. The interactive device according to claim 6, wherein the supporting surface further comprises at least one second partitioning groove formed thereon, wherein the at least one second partitioning groove intersects perpendicularly with the at least one first partitioning groove.

8. The interactive device according to claim 1, further comprises a third functional element disposed on a part of yet another one of the plurality of mounting regions.

9. The interactive device according to claim 1, further comprising a third functional element disposed on a part of at least two of the plurality of mounting regions.

10. The interactive device according to claim 1, wherein a projected area of the second functional element on the supporting base is greater than or equal to a projected area of the first functional element on the supporting base on the basis of the supporting base and the first functional element and the second functional element being all parallel to each other and being equidistant from each other.

11. The interactive device according to claim 1, wherein the supporting base
further comprises:
a circuit board disposed in the internal space;
a plurality of electrical interfaces formed on the supporting surface, wherein the plurality of electrical interfaces electrically connect to the circuit board; and
a circuit control unit disposed on the circuit board and electrically connected to each of the plurality of electrical interfaces.

12. The interactive device according to claim 11, wherein each of the plurality of electrical interfaces includes a positioning portion and an electrode portion, so that the first functional element or the second functional element electrically connects to the electrode portion.

13. The interactive device according to claim 12, wherein the electrode portion further includes a plurality of electrical terminals.

14. The interactive device according to claim 11, further comprising an electronic component disposed in the internal space and electrically connected to the circuit control unit, wherein the electronic component is selected from one of a central processing unit, a bus control unit, a wireless communication unit, a microprocessor unit, a graphics processing unit, a digital signal processing unit, and a memory.

15. The interactive device according to claim 1, wherein the first functional element further comprises
a plurality of first side surfaces that surround the first functional surface and the first mounting surface; and
the second functional element further comprises a plurality of second side surfaces that surround the second functional surface and the second mounting surface.

16. The interactive device according to claim 15, wherein a connecting slot is formed on one of the first side surfaces or one of the second side surfaces.

17. An interactive device, comprises:
a supporting base comprising a supporting surface, a bottom surface and an internal space formed between the supporting surface and the bottom surface, wherein a plurality of electrical interfaces formed on the supporting surface;
a circuit board disposed in the internal space, wherein a circuit control unit disposed on the circuit board and electrically connected to each of the plurality of electrical interfaces; and
a first functional element comprising a first functional surface, a first mounting surface, and a plurality of first side surfaces that surround the first functional surface and the first mounting surface.

18. The interactive device according to claim 17, wherein a connecting slot is formed on one of the first side surfaces.

19. An interactive device, comprises:
a supporting base comprising a supporting surface, a bottom surface, an internal space formed between the supporting surface and the bottom surface; and
a first mounting region, a second mounting region, a third mounting region, and a fourth mounting region defined on the supporting surface;
wherein an area of the first mounting region is equal to an area of the third mounting region and smaller than an area of the second mounting region, and the area of the second mounting region is equal to an area of the fourth mounting region and larger than the area of the first mounting region.

20. The interactive device according to claim 19, further comprising:
a plurality of electrical interfaces formed on the supporting surface; and
a circuit board disposed in the internal space, wherein a circuit control unit disposed on the circuit board and electrically connected to each of the plurality of electrical interfaces.
